(19) United States
(12) Patent Application Publication
(10) Pub. No.: US 2009/0003474 A1
(43) Pub. Date: Jan. 1, 2009

(54) CONSTANT MODULUS MIMO PRECODING FOR CONSTRAINING TRANSMIT ANTENNA POWER FOR DIFFERENTIAL FEEDBACK

(75) Inventors: Kyle Jung-Lin Pan, Smithtown, NY (US); Donald M. Grieco, Manhasset, NY (US); Robert L. Olesen, Huntington, NY (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL TECHNOLOGY CORPORATION, Wilmington, DE (US)

(21) Appl. No.: 12/142,024

(22) Filed: Jun. 19, 2008

Related U.S. Application Data
(60) Provisional application No. 60/944,804, filed on Jun. 19, 2007.
(60) Provisional application No. 60/944,889, filed on Jun. 19, 2007.

(51) Int. Cl. H04L 27/28

(52) U.S. Cl. 375/260

(57) ABSTRACT

A method and apparatus for constraining power amplifier (PA) imbalance includes using a constant modulus (CM) criterion to ensure PA balance when using differential feedback.

### CROSS REFERENCE TO RELATED APPLICATIONS

This application claims the benefit of U.S. provisional applications 60/944,804 filed on Jun. 19, 2007, and 60/944,889 filed on Jun. 19, 2007, which are incorporated by reference as if fully set forth.

### TECHNOLOGY FIELD

The method and apparatus are related to wireless communications. More particularly, the method and apparatus are related to constant modulus (CM) multiple in-multiple out (MIMO) preceding for constraining transmit antenna power for differential feedback.

### BACKGROUND

Third generation partnership project 3GPP and 3GPP2 are considering long term evolution LTE for radio interface and network architecture. There is an ever-increasing demand on wireless operators to provide better quality voice and high-speed data services. As a result, wireless communication systems that enable higher data rates and higher capacities are a pressing need.

To achieve this, it is becoming increasingly popular to use multi-antenna systems in wireless communication networks to obtain advantages of increased channel capacity, spectrum efficiency, system throughputs, peak data rates and/or link reliability. Such multi-antenna systems are generically referred to as multiple-input-multiple-output (MIMO) systems but may also include multiple-input-single-output (MISO) and or single-input-multiple-output (SIMO) configurations.

MIMO systems promise high spectral efficiency and have been proposed in many wireless communication standards. Precoding is a technique used to provide increased array and/or diversity gains. Precoding can be used to enhance communications for spatially multiplexed or space-time coded MIMO systems.

To avoid a channel mismatch between transmitting and receiving signals, preceding information must be communicated from a transmitter, (e.g., a base station), to a receiver, (e.g., a wireless transmit/receive unit (WTRU)). This is particularly important for MIMO data demodulation when preceding is used. When a receiver uses incorrect channel responses for data detection, significant performance degradation can occur.

Generally, preceding information may be communicated using explicit control signaling, particularly when the transmitter and receiver are restricted to the use of limited sets of antenna weights and coefficients for preceding. The limited sets of antenna weights and coefficients are sometimes referred to as a preceding codebook. Explicit signaling to communicate preceding information from a transmitter to a receiver may incur large signaling overhead, particularly for a large size codebook. This signaling overhead is magnified when frequency selective preceding is used.

Efficient signaling is essential to evolved universal terrestrial radio access (E-UTRA). A low overhead control signaling scheme can improve MIMO link performance, system capacity, system throughputs, information data rates and increased spectrum efficiency. One such scheme is differential feedback of preceding information.

For a given precoder matrix, power amplifier (PA) imbalance occurs when the average power per physical antenna is different for each antenna. An issue in any wireless communication system is the fact that there may be PA imbalance, which would require using a large power amplifier to compensate for the imbalance. Using an optimum preceding matrix for differential feedback would result in increased performance, but would also bring with it the problem of high power imbalance.

It would therefore be beneficial to provide a method and apparatus to address the PA imbalance issue, and in particular a CM preceding matrix, when differential feedback is used.

### SUMMARY

A method and apparatus are used for constraining power amplifier (PA) imbalance in wireless communications when using differential feedback. The method includes using a constant modulus (CM) criterion to ensure PA balance.

### BRIEF DESCRIPTION OF THE DRAWINGS

A more detailed understanding may be had from the following description, given by way of example and to be understood in conjunction with the accompanying drawings wherein:

FIG. 1 is a functional block diagram of a CM based MIMO preceding for a differential feedback system;

FIG. 2 is a functional block diagram of a CM based MIMO preceding for an alternative implementation of a differential feedback system;

FIG. 3 is a flow diagram of a feedback scenario when there are N sub-bands; and

FIG. 4 is a functional block diagram of a generation device.

### DETAILED DESCRIPTION

When referred to hereafter, the terminology “wireless transmit/receive unit (WTRU)” includes but is not limited to a user equipment (UE), a mobile station (STA), a fixed or mobile subscriber unit, a pager, a cellular telephone, a personal digital assistant (PDA), a computer, or any other type of user device capable of operating in a wireless environment. When referred to hereafter, the terminology “base station” includes but is not limited to a Node-B, a site controller, an access point (AP), or any other type of interfacing device capable of operating in a wireless environment.

The method and apparatus are directed toward a CM for MIMO codebook feedback and preceding to address power amplifier (PA) imbalance issues for differential feedback. The method and apparatus use a CM quantization to ensure PA balance for differential feedback. PA balance is defined such that for a given preceding matrix, the average power per physical antenna is the same for each antenna. One solution is to use a CM codebook for differential preceding to address PA imbalance.

A CM-based MIMO preceding for differential feedback is used to address the PA imbalance issue. In this design, reduced feedback overhead is maintained and the CM criterion is used for designing the precoding/feedback and ensuring PA balance.

In general, the principles for CM-based differential feedback are to use feedback to generate a preceding matrix, then use a constant modulus codebook to quantize and convert the preceding matrix to a constant modulus quantized preceding matrix. The resultant differential preceding matrix satisfies a CM criterion, and thus meets antenna power constraints, resulting in PA balance.

A CM codebook for differential feedback and preceding can be generated from a non-CM codebook. Each codeword of non-CM codebook is tested against CM requirement and codewords which meet CM requirement are kept and codewords which do not meet CM requirement are discarded. In other words, the CM codebook can be generated by trimming and removing non-CM codewords from non-CM codebook.

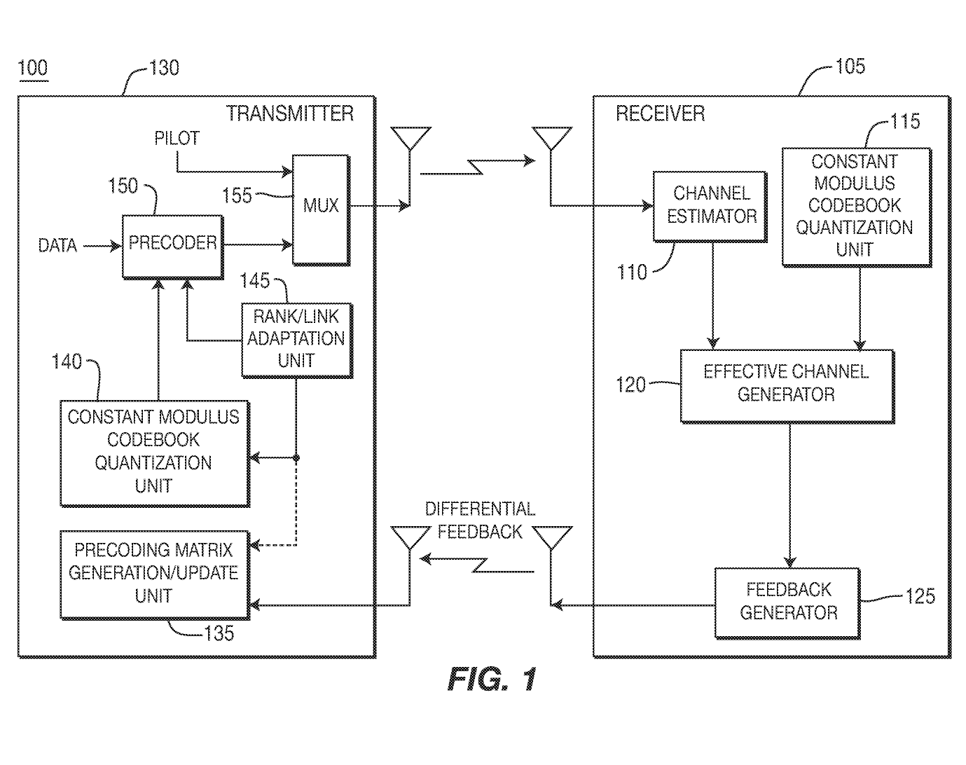

FIG. 1 is a functional block diagram of CM based MIMO preceding for differential feedback 100. As shown in FIG. 1, the receiver 105 includes a channel estimator 110, a constant modulus codebook quantization unit 115, an effective channel generator 120, and a feedback generator 125 for generating feedback bits. The transmitter 130 includes a preceding matrix generation/update unit 135, a constant modulus codebook quantization unit 140, a rank/link adaptation unit 145, a precoder 150, and a multiplexer 155.

Referring to FIG. 1, a signal is received at the channel estimator 110, which produces estimated channel responses. The effective channel generator 120 receives the channel estimates from the channel estimator 110. The effective channel generator 120 can also receive quantized data from the constant modulus codebook quantization unit 115. Once the data is received, the effective channel generator 120 searches the codebook index and transforms channel responses to effective channel responses that include preceding effects. The feedback generator 125 then generates and transmits preceding information in either full or differential feedback information.

Referring to FIG. 1, the preceding matrix generation/update unit 135 receives the feedback bit. The preceding matrix generation/update unit 135 can also receive data from the rank/link adaptation unit 145. The constant modulus codebook quantization unit 140 receives the data and quantizes the preceding matrix. The precoder 150 receives the quantized data and generates a preceding matrix for a specific time or frequency instance T[n,k] where n may represent time index and k may represent frequency index. The multiplexer 155 then combines the data received from the precoder with a pilot signal and transmits the combined data back to the receiver 105. Note that the time instance could be a sub-frame, transmission time interval (TTI), timeslot, etc. A frequency instance could be a frequency sub-band, resource block (RB), resource block group (RBG), sub-carrier, etc.

Table 1 is an example of a CM codebook, which is the CM codebook specified in LTE for NodeB transmission with four antennas. The same CM codebook may be used at reset, initialization and tracking. Alternatively, different CM codebooks may also be used for reset, initialization and tracking.

TABLE 1

| Codebook | | Number of layers υ | | | |
|---|---|---|---|---|---|
| index | uₙ | 1 | 2 | 3 | 4 |
| 0 | u₀ = [1 −1 −1 −1]^{T} | W₀^{{1}} | W₀^{{14}}/\sqrt{2} | W₀^{{124}}/\sqrt{3} | W₀^{{1234}}/2 |
| 1 | u₁ = [1 −j 1 j]^{T} | W₁^{{1}} | W₁^{{12}}/\sqrt{2} | W₁^{{123}}/\sqrt{3} | W₁^{{1234}}/2 |
| 2 | u₂ = [1 1 −1 1]^{T} | W₂^{{1}} | W₂^{{12}}/\sqrt{2} | W₂^{{123}}/\sqrt{3} | W₂^{{3214}}/2 |
| 3 | u₃ = [1 j 1 −j]^{T} | W₃^{{1}} | W₃^{{12}}/\sqrt{2} | W₃^{{123}}/\sqrt{3} | W₃^{{3214}}/2 |
| 4 | u₄ = [1 (−1 − j)/\sqrt{2} −j (1 − j)/\sqrt{2}]^{T} | W₄^{{1}} | W₄^{{14}}/\sqrt{2} | W₄^{{124}}/\sqrt{3} | W₄^{{1234}}/2 |
| 5 | u₅ = [1 (1 − j)/\sqrt{2} j (−1 − j)/\sqrt{2}]^{T} | W₅^{{1}} | W₅^{{14}}/\sqrt{2} | W₅^{{124}}/\sqrt{3} | W₅^{{1234}}/2 |
| 6 | u₆ = [1 (1 + j)/\sqrt{2} −j (−1 + j)/\sqrt{2}]^{T} | W₆^{{1}} | W₆^{{13}}/\sqrt{2} | W₆^{{134}}/\sqrt{3} | W₆^{{1324}}/2 |
| 7 | u₇ = [1 (−1 + j)/\sqrt{2} j (1 + j)/\sqrt{2}]^{T} | W₇^{{1}} | W₇^{{13}}/\sqrt{2} | W₇^{{134}}/\sqrt{3} | W₇^{{1324}}/2 |
| 8 | u₈ = [1 −1 1 1]^{T} | W₈^{{1}} | W₈^{{12}}/\sqrt{2} | W₈^{{124}}/\sqrt{3} | W₈^{{1234}}/2 |
| 9 | u₉ = [1 −j −1 −j]^{T} | W₉^{{1}} | W₉^{{14}}/\sqrt{2} | W₉^{{134}}/\sqrt{3} | W₉^{{1234}}/2 |
| 10 | u₁₀ = [1 1 1 −1]^{T} | W₁₀^{{1}} | W₁₀^{{13}}/\sqrt{2} | W₁₀^{{123}}/\sqrt{3} | W₁₀^{{1324}}/2 |
| 11 | u₁₁ = [1 j −1 j]^{T} | W₁₁^{{1}} | W₁₁^{{13}}/\sqrt{2} | W₁₁^{{134}}/\sqrt{3} | W₁₁^{{1324}}/2 |
| 12 | u₁₂ = [1 −1 −1 1]^{T} | W₁₂^{{1}} | W₁₂^{{12}}/\sqrt{2} | W₁₂^{{123}}/\sqrt{3} | W₁₂^{{1234}}/2 |
| 13 | u₁₃ = [1 −1 1 −1]^{T} | W₁₃^{{1}} | W₁₃^{{13}}/\sqrt{2} | W₁₃^{{123}}/\sqrt{3} | W₁₃^{{1324}}/2 |
| 14 | u₁₄ = [1 1 −1 −1]^{T} | W₁₄^{{1}} | W₁₄^{{13}}/\sqrt{2} | W₁₄^{{123}}/\sqrt{3} | W₁₄^{{3214}}/2 |
| 15 | u₁₅ = [1 1 1 1]^{T} | W₁₅^{{1}} | W₁₅^{{12}}/\sqrt{2} | W₁₅^{{123}}/\sqrt{3} | W₁₅^{{1234}}/2 |

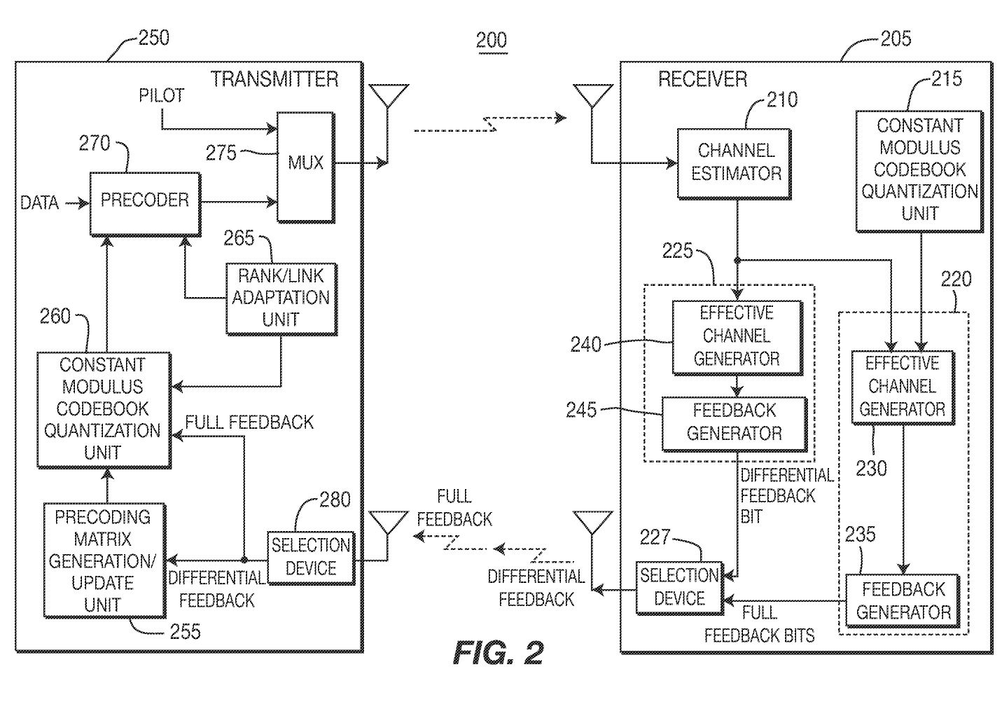

FIG. 2 is a functional block diagram of CM based MIMO preceding for differential feedback in accordance with an alternative embodiment. As shown in FIG. 2, the receiver 205 includes a channel estimator 210, a constant modulus codebook quantization unit 215, a full feedback processing unit 220, a differential feedback processing unit 225 and a selection device 227. The full feedback processing unit 220 contains an effective channel generator 230 for full feedback, and a feedback generator 235 for generating full feedback bits. Similarly, the differential feedback processing unit 225 contains an effective channel generator 240 for differential feedback, and a feedback generator 245 for generating differential feedback bits. These two processing units allow the receiver to transmit both differential feedback and full feedback signals or switch between differential feedback and full feedback transmissions at the selection device 227. The transmitter 250 includes a preceding matrix generation/update unit 255, a constant modulus codebook quantization unit 260, a rank/link adaptation unit 265, a precoder 270, and a multiplexer 275 and a selection device 280. The transmitter is configured to receive differential feedback signals, full feedback signals or both differential and full feedback signals at the selection device 280.

Referring to FIG. 2, data is received at the channel estimator 210. The full feedback and differential feedback processing units 220, 225 receive data from the channel estimator 210. The full feedback processing unit 220 is also configured to receive data from the constant modulus codebook quantization unit 215. Once the data is received, the respective effective channel generators 230, 240 search the codebook index and transform channel responses to effective channel responses that include preceding effects. The respective feedback generators 235, 245 then generate and transmit preceding information in either full feedback or differential feedback bits.

Referring again to FIG. 2, the preceding matrix generation/update unit 255 receives the differential feedback and detects one or two bits. The preceding matrix generation/update unit 255 sends the data to the constant modulus codebook quantization unit 260. When the transmitter 250 receives full feedback data, the constant modulus codebook quantization unit 260 receives the full feedback and quantizes the preceding matrix. The rank/link adaptation unit 265 sends data to the constant modulus codebook quantization unit 260 and the precoder 270. The rank/link adaptation block adjusts the number of transmission layers and modulation and coding rate. The precoder 270 receives the quantized data and generates a preceding matrix for a specific time or frequency instance T[n,k]. The multiplexer 275 then combines the data received from the precoder with a pilot signal and transmits the combined data back to the receiver 205.

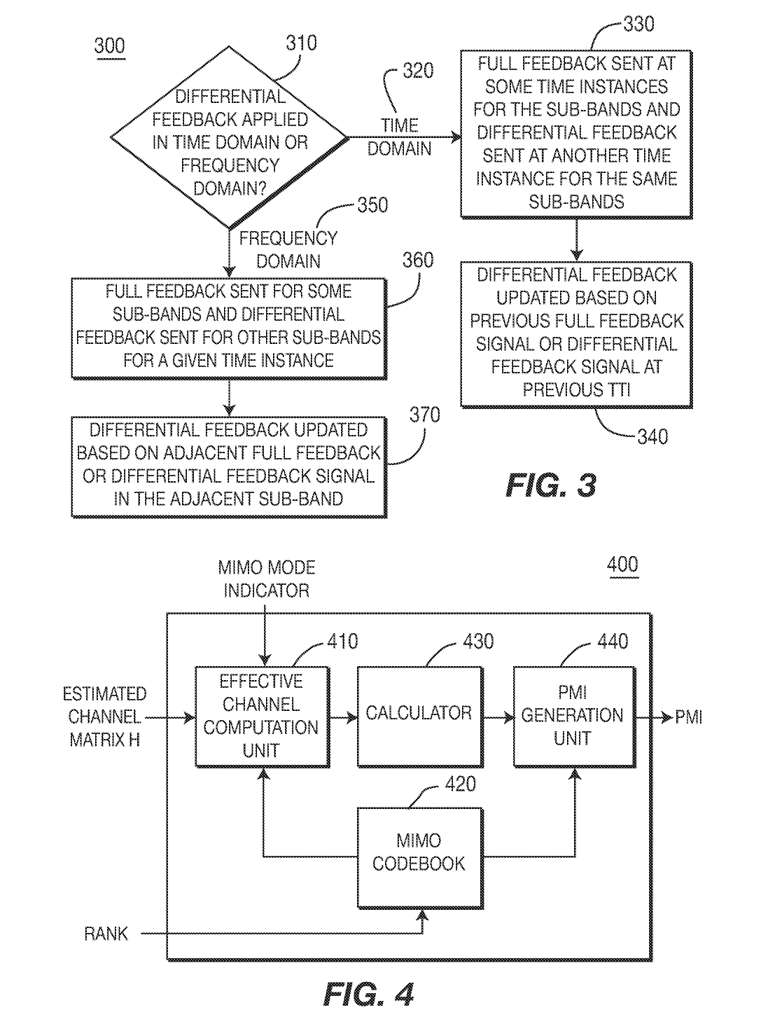

FIG. 3 shows the example that when there are N sub-bands 300, either full feedback or differential feedback may be sent for each sub-band 310. If differential feedback is applied in time domain 320, a full feedback signal may be sent at some time instances for the sub-bands and differential feedback may be sent at another time instance for the same sub-bands 330. The determination as to what time instances to send full/differential feedback could be based on any channel condition, such as WTRU speed, etc. For example, at low speed, differential feedback may be used most of the time and full feedback can be used occasionally, while at high speed, full feedback may be used more frequently. The feedback time interval for full and differential feedback can be configured by base station or network. The differential feedback is updated based on the previous full feedback signal or differential feedback signal at the previous TTI in which feedback signals are sent 340. If differential feedback is applied in the frequency domain 350, the full feedback signal may be sent for some sub-bands and differential feedback may be sent for other sub-bands for a given time instance 360. The determination as to which sub-bands receive full/differential feedback can be made, for example, when one feedback mode is selected based on, for example, WTRU speed. Which sub-bands receive full or differential feedback can be pre-defined or dynamically selected based on the feedback mode. The differential feedback is updated based on the adjacent full feedback or differential feedback signal in the adjacent sub-bands 370.

An optimum arrangement for when, where, and how often for sending which kind of feedback signal (e.g., full feedback, differential feedback) in which time interval or frequency sub-band can be designed and determined for a given assumption, such as channel environment and system configurations. For frequency domain feedback the following modes may be used. One feedback mode, feedback mode A, includes sending full feedback for the central sub-band and differential feedback for the remaining side sub-bands in TTIs that require feedback. The central sub-band can be the center sub-band with the strongest power, or it can be a combination of one or more sub-bands near the center of the bandwidth. Another feedback mode, feedback mode B, includes sending full feedback in the first third and the second third sub-bands and differential feedback for the other remaining sub-bands in TTIs that require feedback. For time domain feedback, the following feedback modes may be used. In feedback mode C, feedback signals at different TTIs may be independent, i.e., differential feedback is not performed across TTIs for those sub-bands. In feedback mode D, feedback signals at different TTIs may be dependent, i.e., differential feedback is performed across TTIs for those sub-bands with full feedback information. The description of these four feedback modes are for example only and it is understood that other modes may also be used.

Feedback may also be applied to both time and frequency domain. For frequency-time domain feedback the following modes may be used: combination of feedback modes A and C (call this feedback mode E), A and D (feedback mode F), B and C (feedback mode G), and B and D (feedback mode H).

Three possible feedback mode implementations are: 1) static feedback mode, where one of the feedback modes is pre-selected and implemented in the system, i.e., it is fixed once it is pre-selected, 2) semi-static feedback mode, where one of the feedback modes is selected and communicated between the transmitter and receiver, i.e., it is dynamic at some degrees and the change of feedback mode is slow and is communicated by higher layer signaling, e.g., RRC signaling, and 3) dynamic feedback mode, where one of these feedback modes is dynamically selected and communicated between the transmitter and receiver, i.e., it is fully dynamic and the change of feedback mode is slow and is communicated by lower layer signaling, e.g., physical layer or Layer1/Layer2 signaling.

FIG. 4 is a functional block diagram of a generation device 400. Data is received at the effective channel computation unit 410. The effective channel computation unit transforms channel responses to effective channel responses that include preceding effects. The effective channel responses or channel matrix can be obtained by multiplying the channel responses or channel matrix with a preceding matrix or vector. The types of data that the effective channel computation unit can receive include MIMO mode indications, estimated channel matrix, and information from the MIMO codebook 420. Following the effective channel computation, the data is forwarded to a calculator 430, which performs calculations such as overall rate, channel capacity, means square error (MSE), signal-to-interference-noise ratio (SINR), and the like. The preceding matrix index (PMI) generation unit 440 received data from the calculator 430 and the MIMO codebook 420, and generates the PMI.

It should be noted that the principles described can be applied for differential feedback methods using either a single bit or multiple bits in the feedback signal.

Although the features and elements of the present invention are described in the preferred embodiments in particular combinations, each feature or element can be used alone without the other features and elements of the preferred embodiments or in various combinations with or without other features and elements of the present invention. The methods or flow charts provided in the present invention may be implemented in a computer program, software, or firmware tangibly embodied in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) module.

What is claimed is:

1. A wireless transmit/receive unit (WTRU) configured to perform constant modulus (CM) based multiple input multiple output (MIMO) preceding for differential feedback, the WTRU comprising:
a channel estimator;
an effective channel generation unit configured to search a codebook index; and
a CM codebook quantization unit configured to receive data including a preceding matrix, and to quantize the preceding matrix.

2. The WTRU of claim 1, wherein the effective channel generation unit is further configured to generate feedback bits.

3. The WTRU of claim 2, wherein the feedback bits are differential feedback bits.

4. The WTRU of claim 2, wherein the feedback bits are full feedback bits.

5. The WTRU of claim 1 further comprising a selection device that switches an output from differential feedback bits to full feedback bits.

6. A base station configured to perform constant modulus (CM) based multiple input multiple output (MIMO) preceding for differential feedback, the base station comprising:
a precoder configured to receive quantized data and generate a preceding matrix for a time or frequency instance;
a CM codebook quantization unit configured to receive data and quantize the precoding matrix; and
a preceding matrix generation/update functional unit configured to receive feedback bits.

7. The base station of claim 6 further comprising a selector that switches an input from differential feedback to full feedback.

8. A generation device comprising:
an effective channel computation unit;
a calculator;
a multiple input multiple output (MIMO) codebook; and
a preceding matrix index (PMI) generation unit configured to receive data from the calculator and the MIMO codebook, and generate a PMI.

9. The generation device of claim 8, wherein the calculator is configured to perform calculations including overall rate, channel capacity, means square error (MSE), and signal-to-interference-noise ratio (SINR).

10. A method for constraining power amplifier (PA) imbalance in wireless communications using a constant modulus (CM) criterion for differential feedback, the method comprising:
receiving a signal including a precoding matrix;
quantizing the precoding matrix;
generating feedback bits based on data from a channel estimator and the quantized precoding matrix; and
transmitting the feedback bits.

11. The method of claim 10, wherein the preceding matrix is a multiple input multiple output (MIMO) preceding matrix for differential feedback.

12. The method of claim 10, wherein differential feedback is used to generate and update a preceding matrix.

13. The method of claim 10, wherein a CM codebook is used for quantizing and converting a preceding matrix to a CM quantized preceding matrix.

14. The method of claim 10, wherein a CM codebook is used at reset and at initialization.

15. The method of claim 10, wherein a first CM codebook is used for reset and a second CM codebook is used for tracking.

16. The method of claim 10, wherein the feedback bits are transmitted in time domain.

17. The method of claim 10, wherein the feedback bits are transmitted in frequency domain.

18. The method of claim 10, wherein the feedback bits are transmitted in time domain and frequency domain.

19. A method for constraining power amplifier (PA) imbalance in wireless communications using a constant modulus (CM) criterion for differential preceding, the method comprising:
receiving feedback bits;
generating a preceding matrix based on data from a rank/link adaptation unit and a CM codebook quantization unit; and
transmitting a signal including the preceding matrix.

20. The method of claim 19, wherein the feedback bits are received in time domain.

21. The method of claim 19, wherein the feedback bits are received in frequency domain.

22. The method of claim 19, wherein the feedback bits are received in time domain and frequency domain.

23. The method of claim 19, wherein the preceding matrix is a multiple input multiple output (MIMO) preceding matrix for differential preceding.

24. The method of claim 19, further comprising using a CM codebook for differential preceding.

25. A method for constraining power amplifier (PA) imbalance in wireless communications including N sub-bands, the method comprising:
applying differential feedback in time domain;
sending full feedback at a first time instance for all sub-bands, the first time instance based on a channel condition;
sending differential feedback at a second time instance for all sub-bands, the second time instance based on the channel condition; and
updating the differential feedback.

26. The method of claim 25, wherein the updating the differential feedback is based on a full feedback signal.

27. The method of claim 25, wherein the updating the differential feedback is based on a differential feedback signal at a previous transmission time interval (TTI).

28. A method for constraining power amplifier (PA) imbalance in wireless communications including N sub-bands, the method comprising:
applying differential feedback in frequency domain;
sending full feedback for a first set of sub-bands at a time instance based on a channel condition;
sending differential feedback for a second set of sub-bands at the time instance based on the channel condition; and
updating the differential feedback.

29. The method of claim 28, wherein the updating the differential feedback is based on an adjacent full feedback signal.

30. The method of claim 28, wherein the first set of sub-bands is a central sub-band, and the second set of sub-bands are the remaining sub-bands.

31. The method of claim 28, wherein the first set of sub-bands is the first and second thirds of sub-bands and the second set of sub-bands are the remaining sub-bands.

32. The method of claim 28, wherein the updating the differential feedback is based on a differential feedback signal in an adjacent sub-band.
